(19) United States
(12) Patent Application Publication
(10) Pub. No.: US 2008/0117381 A1
(43) Pub. Date: May 22, 2008

(54) Glasses structure

(76) Inventor: Lin Yun Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/602,213

(22) Filed: Nov. 21, 2006

(51) Int. Cl. G02C 11/02

(52) U.S. Cl. 351/52

(57) ABSTRACT

A glasses structure comprises a glasses body, an optional coupling device, and a decorative device. The glasses body has at least a first fastener on an upper edge. The decorative device can be coupled with the glasses body directly or indirectly. Accordingly, different adornments can be shown easily by wearing the glasses structure so the glasses structure can be widely applied to daily recreation, costume party, Halloween festival, carnival, and so on.

### FIELD OF THE INVENTION

The present invention relates to a glasses structure, and more particularly to a glasses structure having a decorative device attached thereon for facial embellishment.

### BACKGROUND OF THE INVENTION

Many people usually adorn themselves with various peculiar styles in birthday parties, carnivals, or daily funny recreations so as to relax the pressure on the solemn daily life or the job and also to attract companions and friends. Moreover, the Halloween (or called as the eve of All Saints' Day) is celebrated on October 31 each year. In this day, the public places and the dwelling house are adorned with many adornments such as all kinds of specters, witches, and so on. In addition, children and adults also adorned with peculiar outfits to please themselves and others. Furthermore, the children can ask for candy.

For the purposes of adorning with these adornments, some people embellish their whole bodies and some other people embellish their faces partially with various masks or wearable ornaments. However, these adornments are usually limited to witches, elks, supermen, and so on. The adornments are no more interesting if other persons recognize these people's identities or if the fresh feeling disappears. For the purpose of continuing enjoyment, they must readorn themselves. Accordingly, it is more complicated and uneconomical.

### SUMMARY OF THE INVENTION

A major object of the present invention is to disclose a glasses structure having a decorative device attached thereon for facial embellishment.

In order to achieve the above-mentioned object, a glasses structure is comprised of a glasses body, an optional coupling device, and a decorative device. The glasses body has at least a first fastener on an upper edge. The decorative device can be coupled with the glasses body directly or indirectly. Accordingly, different adornments can be shown easily by wearing the glasses structure so the glasses structure can be widely applied to daily recreation, costume party, Halloween festival, carnival, and so on.

In the present invention, the decorative device is a plate with a shape selected from a group consisting of a ghost and a monster, a cute animal, a cartoon personage, or a sign such as a political slogan, a cheer squad slogan, or an advertisement slogan. The decorative device is easily, detachably coupled with the glasses body so as to achieve the purpose of changing the dressing economically and conveniently. Accordingly, different adornments can be shown easily by wearing the glasses structure so the glasses structure can be widely applied to daily recreation, costume party, Halloween festival, carnival, and so on.

### BRIEF DESCRIPTION OF THE DRAWINGS

FIG. 1 is an elevational, disassembled view showing a preferred embodiment of the present invention.

FIG. 2 is an elevational, assembled view showing a preferred embodiment of the present invention.

FIG. 3 is an elevational, disassembled view of a glasses body and a coupling device in accordance with another preferred embodiment of the present invention.

FIG. 4 is an elevational, assembled view of the glasses body and the coupling device in accordance with another preferred embodiment of the present invention.

FIG. 5 is an elevational, disassembled view showing another preferred embodiment of the present invention.

FIG. 6 is an elevational, assembled view showing another preferred embodiment of the present invention.

FIG. 7 is a schematic, cross-sectional view showing that the coupling device is coupled with the glasses body in accordance with the present invention.

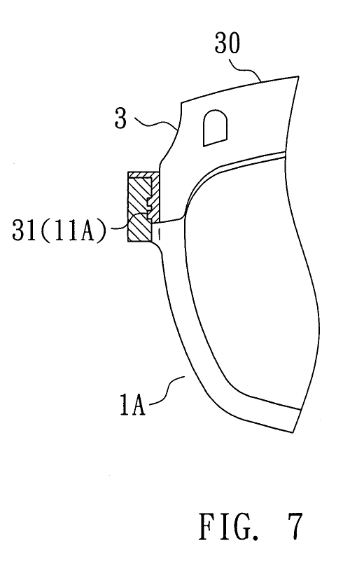

FIG. 8 is an elevational, assembled view showing another preferred embodiment of the present invention.

FIG. 9 is an elevational, disassembled view showing a further preferred embodiment of the present invention.

### DETAILED DESCRIPTION OF THE PREFERRED EMBODIMENT

The description taken with the drawings make the structures, features, and embodiments of the present invention apparent to those skilled in the art how the present invention may be embodied in practice.

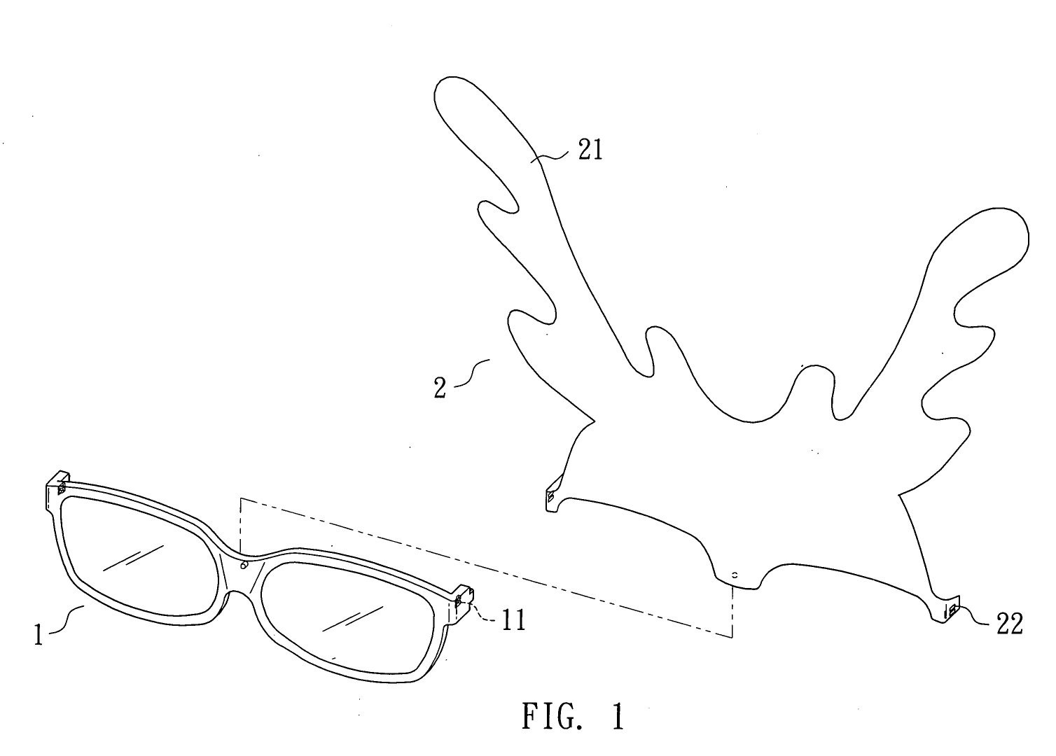

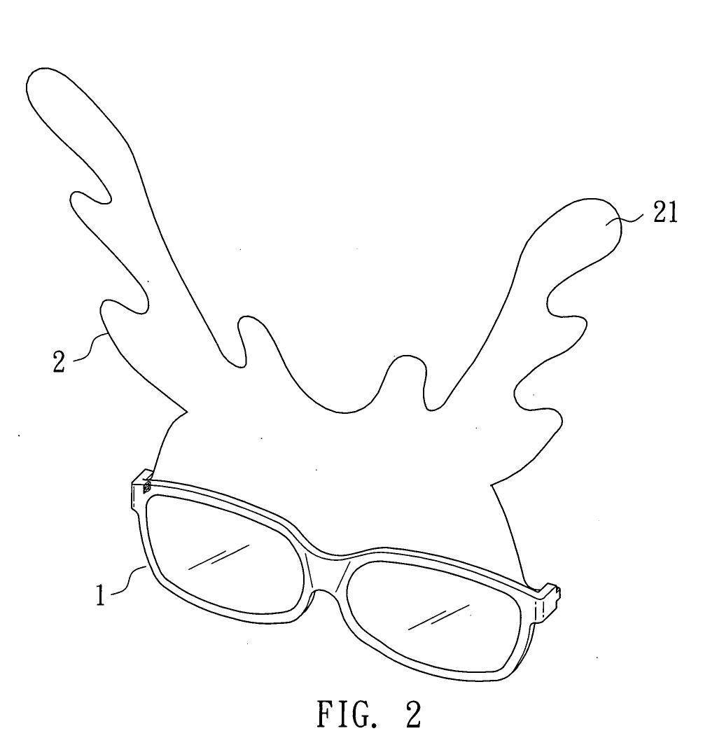

Referring to FIG. 1 and FIG. 2, a glasses structure comprises a glasses body 1 and a decorative device 2. The glasses body 1 has at least a fastener 11 on the upper edge.

The decorative device 2 has a decorative body 21. The decorative body 21 has a coupling means 22 for coupling with the fastener 11 of the glasses body 1. The coupling means 22 is also a fastener for detachably attaching to the fastener 11, wherein the decorative device 2 is a plate with a shape selected from a group consisting of a ghost, a cute animal, a cartoon personage, or a sign such as a political slogan, a cheer squad slogan, or an advertisement slogan.

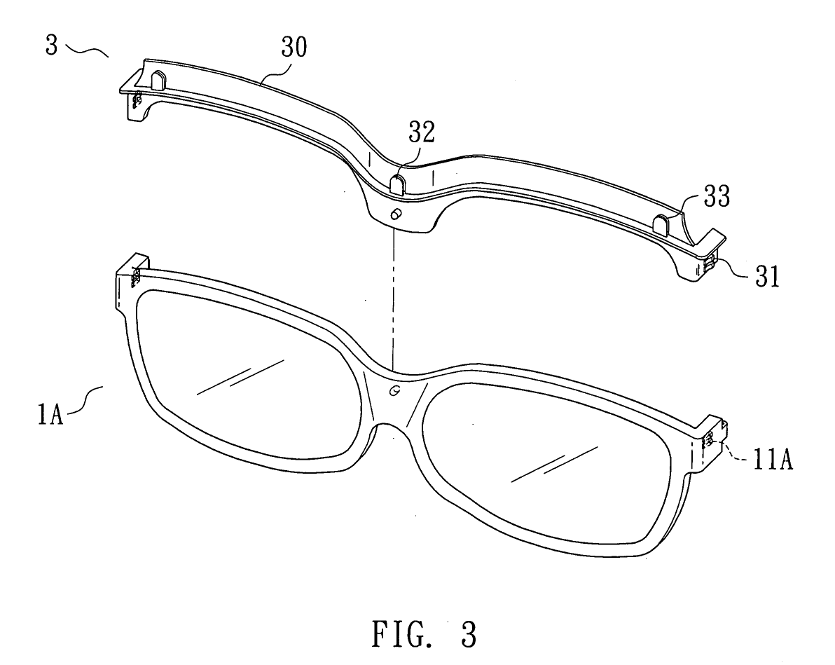

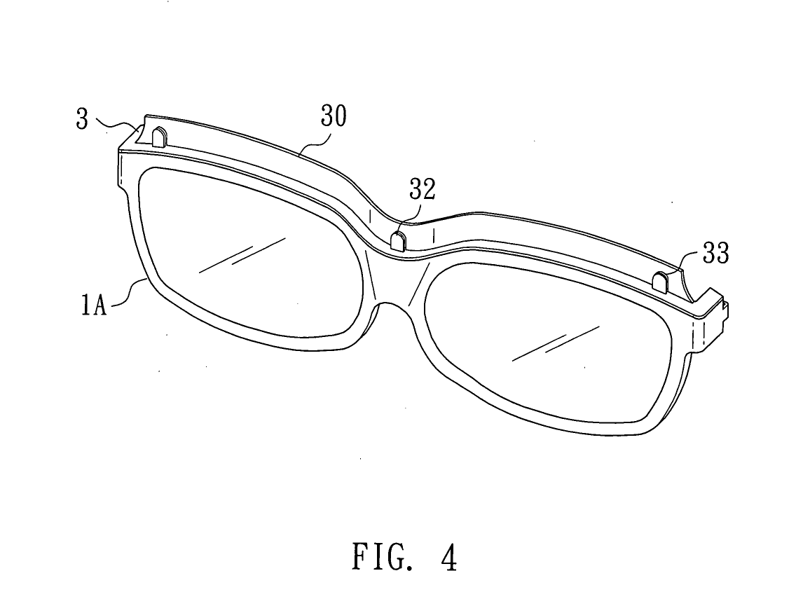

Referring to FIG. 3 and FIG. 4, another preferred embodiment of the present invention is shown.

A glasses structure of the present invention comprises a glasses body 1A, a coupling device 3 and a decorative device 2A. The glasses body 1A has a fastener 11A on the upper edge.

The coupling device 3 has a main body 30 having a fastener 31 for coupling with the fastener 11A of the glasses-body 1A. The coupling device 3 has a fastener 32 for coupling with a coupling means 22A of the decorative device 2A.

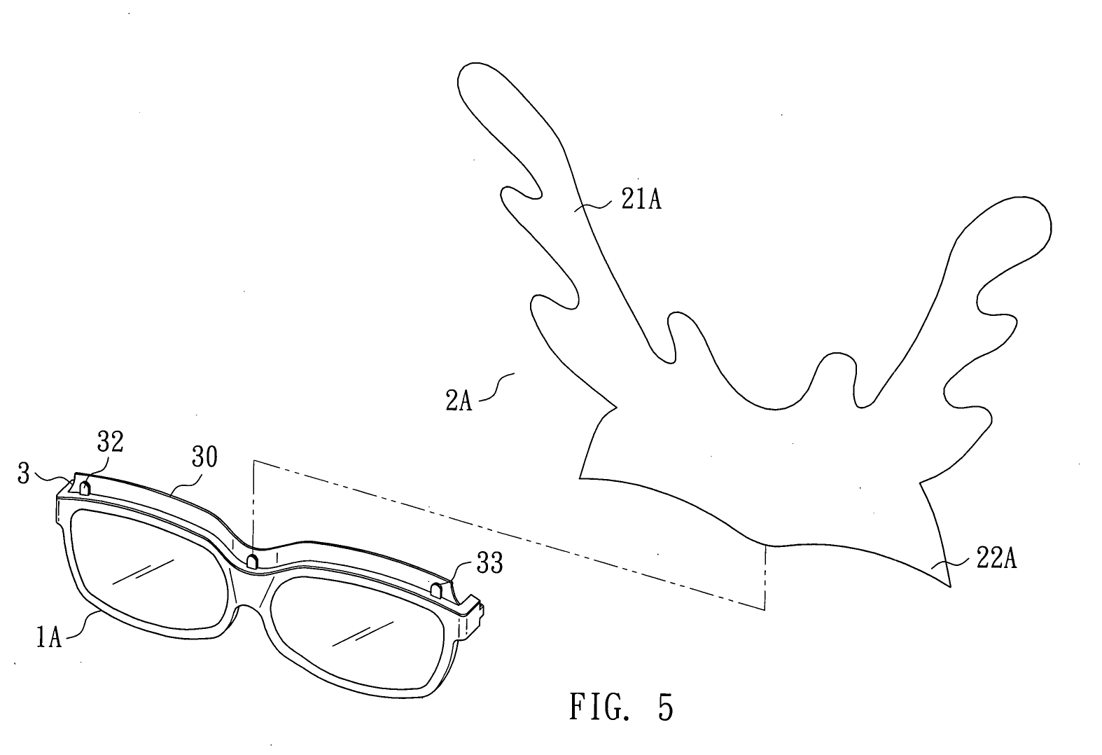

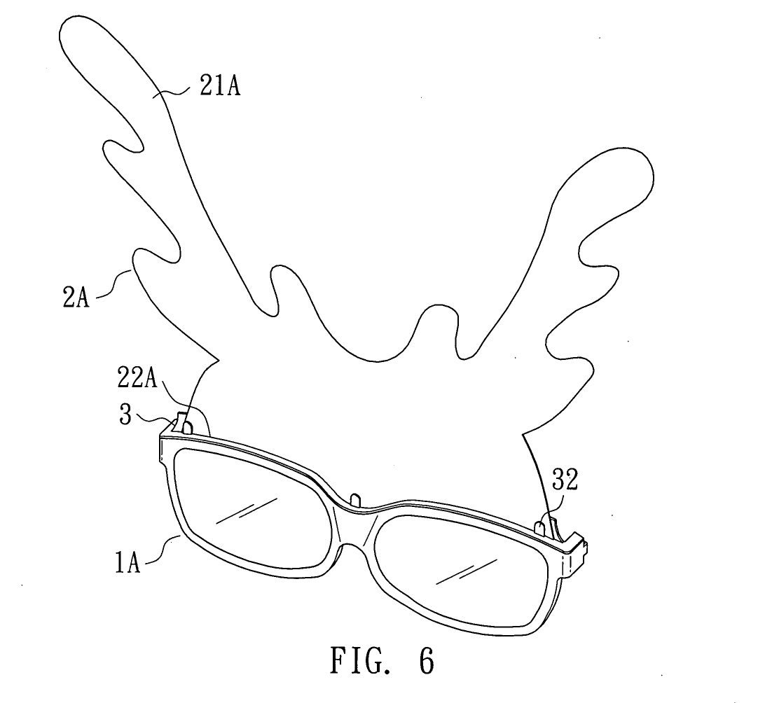

Referring to FIG. 5 and FIG. 6, the decorative device 2A has a decorative body 21A having the coupling means 22A for coupling with the coupling device 3.

In this preferred embodiment, the fastener 32 of the coupling device 3 can be coupled with the coupling means 22A of the decorative device 2A, wherein a gap 33 is formed between the fastener 32 and the main body 30, and the coupling means 22A of the decorative device 2A is in the shape of a plate so that the coupling means 22A can be tightly inserted into the gap 33.

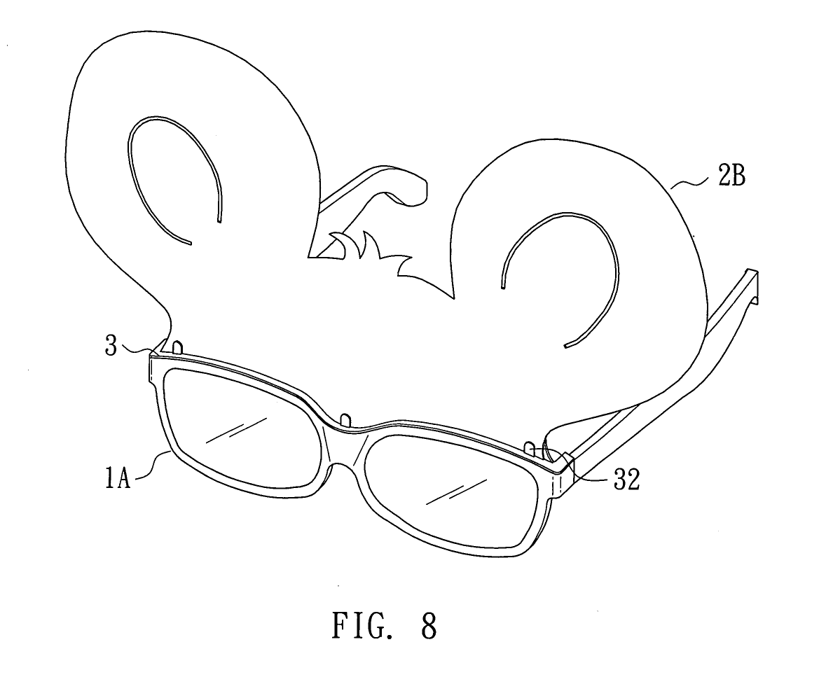

In this preferred embodiment, the decorative device is also a plate with a shape selected from a group consisting of a ghost, a cute animal, a cartoon personage, or a sign such as a political slogan, a cheer squad slogan, or an advertisement slogan. As shown in FIG. 1, the decorative device 2 is in the shape of an elk. As shown in FIG. 8, the elk-shaped decorative device 2B is detachable from the coupling device 3 and can be replaced with the Mickey Mouse-shaped decorative device 2B.

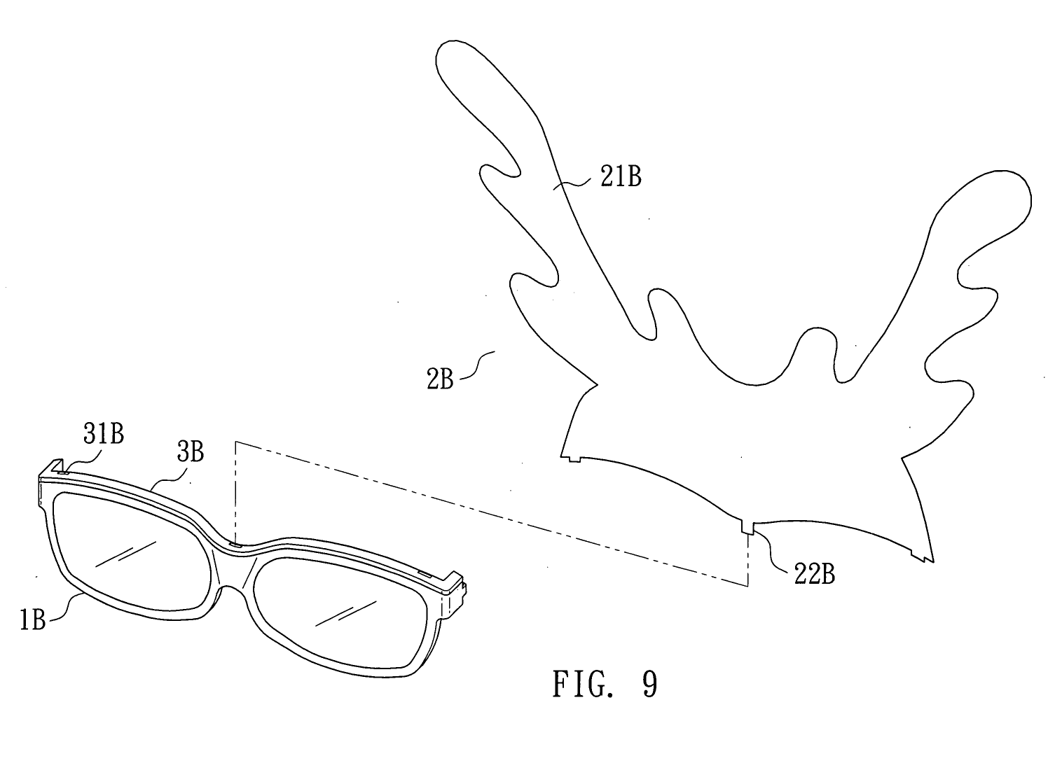

Referring to FIG. 9, in another preferred embodiment of the present invention, a coupling device 3B is coupled with a glasses body 1B, wherein a fastener 31B of the coupling device 3B can be coupled with a coupling means 22B of the decorative device 2B, and wherein the fastener 31B of the coupling device 3B is at least a trench on the top of the coupling device 3B. In addition, the coupling means 22B of the decorative device 2B is an insertion plate extending from the bottom of a decorative body 21B of the decorative device 2B for corresponding insertion into the trench.

As a result, the decorative device 2B is directly, detachably, easily coupled with the glasses body so as to achieve the purpose of changing the dressing economically and conveniently. Accordingly, different adornments can be shown easily by wearing the glasses structure so the glasses structure can be widely applied to daily recreation, costume party, Halloween festival, carnival, and so on.

On the basis of the description mentioned above, the present invention indeed satisfies the requirements for patentability since it provides practicability and has never been published or used publicly. Therefore, it is submitted for a patent.

With the invention thus explained, it is apparent that various modifications and variations can be made without departing from the scope of the invention. It is therefore intended that this invention be limited only as indicated in the appended claims.

What the invention claimed is:

1. A glasses structure comprising:
a glasses body having at least a fastener on an upper edge thereof; and
a decorative device having a decorative body having a fastener for correspondingly, detachably coupling with said fastener of said glasses body.

2. A glasses structure of claim 1, wherein said decorative device is a plate with a shape selected from a group consisting of a ghost, a cute animal, a cartoon personage, or a sign.

3. A glasses structure comprising:
a glasses body having at least a first fastener on an upper edge thereof;
a coupling device having a main body having a second fastener for correspondingly coupling with said first fastener of said glasses body, said main body further having a third fastener for coupling with a coupling means of a decorative device; and
said decorative device having a decorative body having said coupling means for coupling with said coupling device.

4. A glasses structure of claim 3, wherein a gap is formed between said third fastener of said coupling device and said main body, and said coupling means of said decorative device is in the shape of a plate so that said coupling means can be tightly inserted into said gap.

5. A glasses structure of claim 3, wherein said decorative device is a plate with a shape selected from a group consisting of a ghost, a cute animal, a cartoon personage, or a sign.

6. A glasses structure of claim 3, wherein said third fastener of said coupling device is at least a trench on the top of said coupling device, and said coupling means of said decorative device is an insertion plate extending from the bottom of said decorative body for corresponding insertion into said trench.
